(19) United States
(12) Patent Application Publication
(10) Pub. No.: US 2015/0352767 A1
(43) Pub. Date: Dec. 10, 2015

(54) Fabrication of Porous Carbon Nanofibers with Large Power Handling Capability

(71) Applicants: Vibha Kalra, Baltimore, MD (US); Chau Tran, Upper Darby, PA (US)

(72) Inventors: Vibha Kalra, Baltimore, MD (US); Chau Tran, Upper Darby, PA (US)

(21) Appl. No.: 13/688,296

(22) Filed: Nov. 29, 2012

Related U.S. Application Data
(60) Provisional application No. 61/564,562, filed on Nov. 29, 2011.

(51) Int. Cl. B29C 47/00; D01F 9/14; D01F 9/22

(52) U.S. Cl. CPC B29C 47/0004; D01F 9/22; D01F 9/14; B29K 2077/10

(57) ABSTRACT

A method for producing porous nanofibers having tunable meso- and micropores, and the articles produced by the method. In some embodiments, the method comprises electrospinning a polymer blend comprising polyacrylonitrile and a sulfonated polymer dissolved in a solvent to form a fibers; heat treating the mat or web of fibers sequentially at first, second, and optionally third temperatures; and optionally treating the heat treated fibers with an oxidizing agent.

### CROSS REFERENCE TO RELATED APPLICATIONS

The instant application claims priority to U.S. provisional patent application No. 61/564,562, filed Nov. 29, 2011, which is hereby incorporated by reference in its entirety.

### TECHNICAL FIELD

The disclosure relates to carbon nanofiber having large power handling capability and methods of making same.

### BACKGROUND

Electrochemical double layer capacitors (EDLCs, also called supercapacitors or ultracapacitors) are one of the most promising energy storage devices because of their high power density, rapid charging/discharging ability, and long cycle life. Their applications can range from low power mobile devices to high power electric vehicles. The basic operating principle involves the adsorption and desorption of ions at the electrode/electrolyte interface. The key factors that govern the capacitance or performance of these devices are the specific surface area and electrical conductivity of the electrode materials. Porous carbon has been subjected to intensive studies for supercapacitor applications because of its chemical and thermal stability, high conductivity, and relatively low cost. A wide range of porous carbons, such as activated carbon, carbide-derived carbon, carbon onions, carbon nanotubes, carbon aerogel, templated carbon, and carbon nanofibers have been synthesized. These carbonaceous materials exist in various forms, such as powders, monoliths, thin films, fibers, and papers. Among them, carbon papers or fiber mats (woven or non-woven) have certain advantages since they can be fabricated into free-standing electrode materials without the addition of polymeric binding agents that are known to add dead mass and reduce the overall specific capacitance and conductivity of the electrodes.

Electrospinning is a simple process for fabricating non-woven nanofiber mats with high surface area and porosity. A typical electrospinning setup consists of a metallic spinneret, a syringe pump, a high-voltage power supply, and a grounded collector in a humidity controlled chamber. A polymer solution, polymer melt or a sol-gel solution is continuously pumped through the spinneret at a constant rate, while a high voltage gradient is applied between the spinneret tip and the collector substrate. The solvent continuously and rapidly evaporates while the jet stream is whipped and stretched by electrostatic repulsion forming solidified continuous nanofibers (diameters ˜50-500 nm) on the grounded collector. Carbon nanofiber (CNFs) mats can be fabricated by subjecting electrospun nanofibers of an appropriate polymer precursor to stabilization and calcination processes. Cellulose, phenolic resins, polyacrylonitrile (PAN), polybenzimidazol, and pitch-based materials have been electrospun to produce CNFs. Among them, PAN is widely used as a precursor for CNFs due to its excellent electrospinnability and relatively high carbon yield. CNFs produced from electrospinning PAN have been subjected to different chemical or physical activation processes using steam, CO₂, or NaOH to create pores within nanofibers. The activation process further increases the specific surface area of carbon nanofibers thereby enhancing the specific capacitance. These activation processes, however, often create micropores that are less than 2 nm in diameter and provide little control over pore sizes and overall porosity within nanofibers. These materials often show a big drop in capacitance when used in non-aqueous, organic electrolytes and/or at high current densities, conditions that are necessary for most industrial/practical applications. Moreover, the activation step can modify the surface functionalities of CNFs which results in cycling instability of supercapacitors.

Some researchers have electrospun blends of PAN with other sacrificial polymers to generate a range of phase-separated structures in the fibers. The overall idea was that upon calcination at high temperature, PAN will convert to carbon, and the sacrificial polymer would be decomposed out to create intra-fiber pores. The concept is interesting and potentially powerful since the need for activation will be eliminated and the number of steps to produce porous CNFs will be reduced; however, so far not much success in terms of obtaining high surface areas as well as uniform distribution of intra-fiber pores has been seen. Ji et al. (B.-H. Kim, K. S. Yang, H.-G. Woo and K. Oshida, Synthetic Metals, 2011, 161, 1211-1216) prepared porous CNFs by calcining electrospun PAN/poly(L-lactide) nanofibers. They obtained irregular thin long interior pores within carbon nanofibers and a specific surface area of 359 m² g⁻¹. Given that pure PAN-derived non-porous carbon nanofibers have been shown to exhibit a specific area of up to 240 m²/g, little advantage of the presence of a sacrificial polymer was demonstrated. Zhang and co-workers (L. Zhang and Y.-L. Hsieh, European Polymer Journal, 2009, 45, 47-56) electrospun binary solutions of PAN with three different sacrificial polymers, poly(ethylene oxide), cellulose acetate, and poly(methyl methacrylate). Upon removal of the second polymer and subsequent calcination, different features such as grooved, hollow, U-shaped, or collapsed fibers were observed, and there was no report of specific surface area. Niu et al. (H. Niu, J. Zhang, Z. Xie, X. Wang and T. Lin, Carbon, 2011, 49, 2380-2388) produced bonded CNFs by calcining nanofibers containing PAN and thermoplastic polyvinylpyrrolidone. However, structure within nanofibers was not reported. Recently, other researchers also electropsun PAN with catalyst materials such as ZnCl₂ or polymethylhydrosiloxane to create pores on the outer surface of CNFs. The resultant porous CNFs contained majorly micro-pores with a specific surface area of up to 550 m² g⁻¹ and a specific capacitance of up to 160 F g⁻¹ in 6M KOH.

### SUMMARY

The present invention provides a facile route to fabrication of carbon nanofiber mats with uniformly distributed pores within the nanofibers. With the techniques described herein, the pore size can be easily tuned using process and solution parameters. We demonstrate a very high volumetric capacitance of ˜60 F/cm³. The resultant porous nanofiber mat retains its structural integrity in the form of non-woven fiber mats and therefore exhibit flexibility and can be used as electrodes for supercapacitors without the addition of binders. Note that binders are known to increase the resistance and reduce the performance of carbon-onion based supercapacitors, for example. Results including electron micrographs of nanofibers, BET surface area and capacitance measurements are included (described herein).

In some embodiments, the invention concerns methods for forming a porous carbon nanofiber, comprising electrospinning a polymer blend comprising polyacrylonitrile and a sulfonated polymer dissolved in a solvent to form a fibers; heat treating the fibers sequentially at first, second, and optionally third temperatures; and optionally treating the heat treated fibers with an oxidizing agent. In some methods, the polymer blend consists of polyacrylonitrile and a sulfonated polymer. One preferred sulfonated polymer is Nafion. Some fibers are in the form of a mat or web.

In certain embodiments, the method uses solvent comprising toluene, dimethylformamide, chloroform, dichloromethane, dimethylacetamide, acetone, N-methylformamide, N-methylacetamide, N-methylpropanamide, N-ethylacetamide, N-propylpropanamide, N-butylacetamide, N-ethylformamide, or a mixture thereof. One preferred solvent is dimethylformamide.

Some methods use a polymer blend that comprises polyacrylonitrile at a concentration in the range of about 5 wt % to about 95 wt %, relative to a total weight of polymer. In certain embodiments, the polymer blend comprises polyacrylonitrile at a concentration in the range of about 20 wt % to about 50 wt %, relative to a total weight of polymer. Some preferred embodiments, utilize a polymer blend that comprises Nafion® at a concentration in the range of about 5 wt % to about 95 wt %, relative to a total weight of polymer.

Some methods heat treat the fibers at the first temperature is conducted in an oxygen-containing atmosphere at a temperature in the range of about 250° C. to about 300° C. While any suitable oxygen-containing atmosphere may be used, in some embodiments, the oxygen-containing atmosphere is air.

In some embodiments, the sulfonated polymer has a decomposition temperature in air above the first heat treating temperature. In certain embodiments, the heat treating the fibers at the second temperature is conducted in an inert atmosphere at a temperature in the range of about 650° C. to about 1500° C., 650° C. to about 750° C. in some embodiments. For some methods, the heat treating the fibers is done at a third temperature, wherein said heat treating at the third temperature is conducted in an inert atmosphere at a temperature in the range of about 750° C. to about 1500° C., about 750° C. to about 850° C. in some embodiments. While any suitable inert atmosphere may be used, one preferred inert atmosphere is argon.

Once the fibers are heat treated, these treated fibers may be further treated with an oxidizing agent, said oxidizing agent comprising steam.

Some methods use fibers that are in the form of a mat or web. In certain embodiments, the mat or web is pressed and then contacted with an alkaline solution following heat treatment. While any suitable alkaline solution may be used, one preferred alkaline solution is an aqueous KOH solution. Some KOH solutions have a concentration of KOH in the aqueous KOH solution in the range of 10-65 percent by weight.

The invention also concerns porous nanofibers containing micropores and mesopores prepared by the method described herein. Some porous nanofibers have a surface area in the range of about 1200 to about 2000 m²/g, when measured using a nitrogen adsorbent using a multi-point BET method. Some porous nanofibers contains micropores having a cumulative micropore volume in a range of about 0.4 to about 0.8 cc/g, when measured using a nitrogen adsorbent with assumed slit-shaped pores. Certain porous nanofibers contain mesopores having a cumulative mesopore volume in a range of about 0.1 to about 1 cc/g, when measured using a nitrogen adsorbent with assumed slit-shaped pores. Some fiber have pores in the range of 1-10 nm, and in some embodiments, 2-6 nm within the fiber.

In additional embodiments, the invention concerns a plurality of porous nanofibers described herein. In some embodiments, the plurality of nanofibers is in the form of a mat or web. In certain embodiments, the plurality of porous nanofibers exhibit a volumetric capacitance of at least 10 F/cm³. In some embodiments, the plurality of fibers exhibit a volumetric capacitance of 20-61 F/cm³ in the presence of an aqueous electrolyte and 10-51 F/cm³ in the presence of organic electrolyte. In certain embodiments, the plurality of porous nanofibers have a gravimetric capacitance of 51-145 F/g when an organic electrolyte is used and a gravimetric capacitance of 160-220 F/g when an aqueous electrolyte is used. Some mats or webs contain voids in the range of 100 nm to 1 micron between the fibers.

In certain embodiments, at a power density of 20 kW/kg, the invention provides at least 7 Wh/kg of energy density. In some embodiments, use of the nanofibers of the instant invention allows production of devices having an operating voltage of up to 3.2 volts. In certain devices, the inventive fibers retain at least 70% capacitance at 20 A/g current density.

### BRIEF DESCRIPTION OF THE DRAWINGS

The present application is further understood when read in conjunction with the appended drawings. For the purpose of illustrating the subject matter, there are shown in the drawings exemplary embodiments of the subject matter; however, the presently disclosed subject matter is not limited to the specific methods, devices, and systems disclosed. In addition, the drawings are not necessarily drawn to scale. In the drawings:

FIG. 1 is a schematic representation of one embodied process. In step 1, PAN/Nafion composite nanofibers are electrospun using dimethylformamide as the solvent to form smooth nanofibers of PAN/Nafion blend.

FIG. 2 is a schematic of an electrospinning apparatus.

FIG. 3 presents a SEM image of as-made nanofibers of sample 1 (before calcination).

FIG. 4 presents a SEM image of calcined nanofibers of sample 1. Here the PAN has been converted to carbon and Nafion has been selectively removed to form porous carbon nanofibers. Note the uniformly distributed mesopores on each nanofiber

FIG. 5 is the same as FIG. 4 except at high magnification clearly showing pores in each nanofiber

FIG. 6 presents a SEM image of as-made nanofibers of sample 2 (before calcination)

FIG. 7 presents a SEM image of calcined nanofibers of sample 2. Here the PAN has been converted to carbon and Nafion has been selectively removed to form porous carbon nanofibers. See FIG. 8 for high magnification image.

FIG. 8 is the same as FIG. 7 except at high magnification clearly showing pores in each nanofiber. Scale bar=200 nm

FIG. 9 presents a graph of BET surface area and pore size distribution measurements. Not that this method provides the distribution of only the pores inside nanofibers and does not take into account the macropores within nanofiber mats. V_{micro}=cumulative volume of micropores (with diameter<2 nm, Vₘₑₛₒ=cumulative volume of mesopores (2 nm<diameter<50 nm).

FIG. 10 presents a SEM image of as-made nanofibers of sample 3 (before calcination)

FIG. 11 presents a SEM image of calcined nanofibers of sample 3. Here the PAN has been converted to carbon and Nafion has been selectively removed to form porous carbon nanofibers.

FIG. 12 is the same as FIG. 11 except at high magnification clearly showing pores in each nanofiber. Note that the pores created due to removal of Nafion are not clearly visible due to the small diameter as evident from the pore size distribution given in FIG. 14.

FIG. 13 presents a TEM image of microtomed cross-section of calcined nanofiber of sample 3 (porous carbon nanofiber). The light areas are pores and dark regions are carbon.

FIG. 14 shows BET surface area and pore size distribution measurements of calcined sample 3. Note that this method provides the distribution of only the pores inside nanofibers and does not take into account the macropores within nanofiber mats. Vmicro=cumulative volume of micropores (with diameter<2 nm), Vmeso=cumulative volume of mesopores (2 nm<diameter<50 nm)

FIG. 15 presents a plot of capacitance measurement of calcined sample 3 using charge-discharge measurements as a function of time. Total sample volume used=0.0032752 cm³ exhibiting a volumetric capacitance of 29.69 F/cm³

FIG. 16 presents a stability test measurement. Capacitance for same sample as in FIG. 15 measured again after 150 charge-discharge cycles. Total sample volume used=0.0032752 cm³. Volumetric capacitance=31 F/cm³

FIG. 17 presents SEM micrographs of electrospun PAN/Nafion nanofiber mats: a) pure PAN with 10% total solid in DMF, b) 60:40 Nafion:PAN with 15% total solid in DMF c) 80:20 Nafion:PAN with 20% total solid in DMF, d) 80:20 Nafion:PAN with 25% total solid in DMF

FIG. 18 presents SEM micrographs of porous carbon nanofibers formed by calcining nanofibers at different Nafion:PAN blend compositions: a) 60:40 electrospun at 15% total solid concentration, b) 80:20 electrospun at 25% total solid concentration, c) 80:20 electrospun at 20% total solid concentration.

FIG. 19 presents TEM micrographs of microtomed sections of porous carbon nanofibers: a and b) cross-section and longitudinal section of fibers of calcined Nafion:PAN 60:40. Scale bar is 200 nm.

FIG. 20 presents nitrogen sorption isotherms of carbonized a) 60:40 Nafion:PAN and b) 80:20 Nafion:PAN.

FIG. 21 presents. cyclic voltammetry (CV) of carbonized samples prepared from 60:40 Nafion:PAN (top) and 80:20 Nafion:PAN (bottom) at different scan rates.

FIG. 22 presents Ragone plots of different carbonized samples.

FIG. 23 presents Nyquist plots of different carbonized samples.

FIG. 24 presents SEM micrographs of stabilized 60:40 Nafion:PAN. The scale bar is 200 nm.

FIG. 25 presents pore size distributions of carbonized 60:40 Nafion:PAN (left) and 80:20 Nafion:PAN (right).

FIG. 26 presents Nyquist plots for various current collectors.

FIG. 27 presents a SEM image of pressed and calcined carbon nanofibers.

FIG. 28 presents a SEM image of activated carbon nanofibers using 20% KOH solution concentration.

FIG. 29 presents a SEM image of activated carbon nanofibers using 60% KOH solution concentration.

FIG. 30 shows cyclic voltammetry results for a sample (Nafion:PAN 60:40) in 1M TEABF₄ at high scan rate 100 mV/s. The ideal-rectangular shape remains stable up to 3.2 V. This is higher than those achieved by commercial activated carbons (2.8 V) in the same organic electrolyte. Without wanting to be bound by theory, this result is possibly due to the absence of surface functional groups in our materials (compared to activated carbons). Functional groups normally reduce electrical conductivity resulting in low power handling capability and low stability/cyclability (L. L. Zhang, X. S. Zhao, Chemical Society Reviews, 38 (2009) 2520).

FIG. 31 shows cyclic voltammetry results for commercial activated carbon Maxsorb at 50 mV/s. (T. E. Rufford, D. Hulicova-Jurcakova, E. Fiset, Z. Zhu, G. Q. Lu, Electrochemistry Communications, 11 (2009) 974-977.)

FIG. 32 presents a Ragone plot of sample (Nafion:PAN 60:40). The measurement was done in 1M TEABF4 using 2.4 V window. There is only 25% drop at high power density of 20 kW/kg

FIG. 33 presents gravimetric and volumetric capacitance results for a sample (Nafion:PAN 60:40) in 1M TEABF4 at different scan rates.

FIG. 34 presents a volumetric Ragone plot of sample (Nafion:PAN 60:40) with pressing. The measurement was done in 1M TEABF4 using 2.8V window.

FIG. 35 presents a volumetric Ragone plot of sample (Nafion:PAN 60:40) with pressing and activating in 20% KOH. The measurement was done in 1M TEABF4 using 2.8V window.

FIG. 36 presents a volumetric Ragone plot of sample 3 (Nafion:PAN 60:40) with pressing and activating in 30% KOH. The measurement was done in 1M TEABF4 using 2.8V window.

FIG. 37 presents a gravimetric and volumetric capacitance of sample (Nafion:PAN 60:40) activated in different KOH solution concentration. The measurement was done in 1M TEABF4 at 100 mV/s.

FIG. 38 presents results of a test at 5 mV/s scan rate showing 81 F/g capacitance in 1M TEABF₄/acetonitrile.

FIG. 39 shows results from a test at 5 mV/s scan rate showing 41 F/cm³ capacitance in 1M TEABF₄/acetonitrile.

FIG. 40 shows specific capacitance versus current density for carbonized Nafion:PAN 60:40 and carbonized Nafion:PAN 80:20).

### DETAILED DESCRIPTION OF ILLUSTRATIVE EMBODIMENTS

The present invention may be understood more readily by reference to the following description taken in connection with the accompanying Figures and Examples, all of which form a part of this disclosure. It is to be understood that this invention is not limited to the specific products, methods, conditions or parameters described and/or shown herein, and that the terminology used herein is for the purpose of describing particular embodiments by way of example only and is not intended to be limiting of any claimed invention. Similarly, unless specifically otherwise stated, any description as to a possible mechanism or mode of action or reason for improvement is meant to be illustrative only, and the invention herein is not to be constrained by the correctness or incorrectness of any such suggested mechanism or mode of action or reason for improvement. Throughout this text, it is recognized that the descriptions refer both to the features and methods of making and using carbon nanofibers, as well as the carbon nanofibers themselves.

In the present disclosure the singular forms “a,” “an,” and “the” include the plural reference, and reference to a particular numerical value includes at least that particular value, unless the context clearly indicates otherwise. Thus, for example, a reference to “a material” is a reference to at least one of such materials and equivalents thereof known to those skilled in the art, and so forth.

When a value is expressed as an approximation by use of the descriptor “about,” it will be understood that the particular value forms another embodiment. In general, use of the term “about” indicates approximations that can vary depending on the desired properties sought to be obtained by the disclosed subject matter and is to be interpreted in the specific context in which it is used, based on its function. The person skilled in the art will be able to interpret this as a matter of routine. In some cases, the number of significant figures used for a particular value may be one non-limiting method of determining the extent of the word “about.” In other cases, the gradations used in a series of values may be used to determine the intended range available to the term “about” for each value. Where present, all ranges are inclusive and combinable. That is, references to values stated in ranges include every value within that range.

It is to be appreciated that certain features of the invention which are, for clarity, described herein in the context of separate embodiments, may also be provided in combination in a single embodiment. That is, unless obviously incompatible or specifically excluded, each individual embodiment is deemed to be combinable with any other embodiment(s) and such a combination is considered to be another embodiment. Conversely, various features of the invention that are, for brevity, described in the context of a single embodiment, may also be provided separately or in any sub-combination. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation. Finally, while an embodiment may be described as part of a series of steps or part of a more general structure, each said step may also be considered an independent embodiment in itself.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are described herein.

Embodiments of the present invention include methods for forming a porous carbon nanofiber, comprising: electrospinning a polymer blend comprising polyacrylonitrile and a sulfonated polymer dissolved in a solvent to form a fibers; heat treating the mat or web of fibers sequentially at first, second, and optionally third temperatures; and optionally treating the heat treated fibers with an oxidizing agent.

In certain of these embodiments, the polymer blend either comprises or consists of polyacrylonitrile and a sulfonated polymer, preferably wherein the sulfonated polymer is fluorinated, and more preferably where the sulfonated polymer is a copolymer of perfluorosulfonic acid and tetrafluoroethylene. One such polymer is marketed by DuPont Chemicals, Wilmington Del. under the name Nafion™ polymers. Nafion is a perfluorosulfonic acid/TFE copolymer. Sulfonated formulated materials are also available, for example as LIQUION™ LQ-1105 from Ion Power, New Castle, Del.

As used herein, the term “nanofiber” means a fiber having a diameter dimension in the nanometer scale. Accordingly, the cross-sections of the fiber or fibers may be circular, oval, rectangular, square, or any shape which can be defined, for example, by a spinneret. As used herein, the term “nano-scale” refers to dimensions, typically thickness, in the range of about 1 nm to about 1000 nm. Exemplary sub-ranges contemplated by the present invention include between about 100 and about 1000 nm, between about 100 and about 800 nm, between about 100 and about 600 nm, and between about 100 and about 400 nm. Other exemplary ranges include 10-100 nm, 10-200 nm and 10-500 nm. As mentioned, the fibers of the scaffolds of the present invention are preferably generated by an electrospinning process.

As described herein, the polymer blend comprises polyacrylonitrile at concentrations in the range of about 5 wt % to about 95 wt %, preferably in the range of about 20 wt % to about 50 wt %, relative to a total weight of polymer. Similarly, the polymer blends comprises Nafion (or other sulfonated polymers) at a concentration in the range of about 5 wt % to about 95 wt %, relative to a total weight of polymer. For those polymer blends where the polymer blend consists of polyacrylonitrile and the sulfonated polymer, the concentration of the sulfonated polymer/Nafion represents the balance of the weight percentage allowing for the polyacrylonitrile.

Electrospinning is a well-known method for developing polymer nanofibers, and those skilled in the art will appreciate how to practice such art. In the present invention(s), certain embodiments provide that the polymer blend is dissolved in a solvent, typically comprising toluene, dimethylformamide, chloroform, dichloromethane, dimethylacetamide, acetone, N-methylformamide, N-methylacetamide, N-methylpropanamide, N-ethylacetamide, N-propylpropanamide, N-butylacetamide, N-ethylformamide, or a mixture thereof. Solvents comprising dimethylformamide are preferred. Polymer loadings within the solvent are typically in the range of about 10 wt % to about 60 wt %, preferably about 20 wt % to about 40 wt %, relative to the weight of the total blend (including polymer and solvent).

By manipulating the polymer compositions, loadings, and electrospinning conditions, the skilled practitioner can tailor the properties of the final nanofibers. The methods provide ultra-thin nanofibers having extremely high specific surface area, owing to the uniformly distributed pores within the nanofibers. High surface area is known to be the most important characteristic that increases capacitance. Note that the electrode design in this invention retains the morphological advantage often associated with activated carbon fibers and yet increases the surface area many folds due to small diameter and additional pores on the fiber surface. As shown in the results, the specific surface area of these materials is more than 1500 m²/g.

This invention provides materials having three different sizes of pores (micro, meso and macropores) within the same electrode material: (a) micropores having pore diameters<2 nm; (b) mesopores with diameter between 2 and 50 nm; and (c) macropores with diameter>50 nm. While the micropores will increase the specific surface area very efficiently, the mesopores and macropores facilitate the permeation of electrolyte to microporous structure and increase the mobility of the ions in the pore for smooth adsorption/desorption. Large pores are also known to increase capacitance in high power capacitors.

As described above, once the nanofibers are electrospun, various embodiments provide for a series of thermal treatments. In certain of these embodiments, the heat treating the fibers at the first temperature is conducted in an oxygen containing atmosphere, typically air, at a temperature in the range of about 250° C. to about 300° C. Examples are shown within this specification where this temperature is about 280° C. In these methods, the sulfonated polymer has a decomposition temperature in air which is above the first heat treating temperature

In other embodiments, the heat treating the fibers at the second temperature is conducted in an inert atmosphere at a temperature in the range of about 650° C. to about 750° C. Examples are shown within this specification where this temperature is about 700° C.

In still other embodiments, a third heat treating is applied to the fibers, wherein said heat treating at the third temperature is conducted in an inert atmosphere at a temperature in the range of about 750° C. to about 850° C., typically about 800° C. The inert atmosphere may be argon or nitrogen, preferably argon.

In further embodiments, the heat treating steps are followed by treating the fibers with an oxidizing agent, preferably under mild conditions to maintain the essential integrity of the resulting carbon fibers. One such mild oxidizing treatment includes the use of steam (e.g., 25-50 vol %) at elevated temperatures (e.g., 800-1000° C.) under an inert atmosphere (e.g., nitrogen or argon), though other chemical or physical etchants may be used.

With the instant method, the pore sizes are easily controllable and tunable; variability in microporosity and mesoporosity has been achieved, or “tuned” using Nafion/PAN composition and solution concentration in DMF as demonstrated in samples 1-3; macroporosity tuning has been demonstrated with differing nanofiber diameter and mat thickness in step 2. Tunability of the size of meso and macropores is particularly beneficial to accommodate specific ions (with a given size) in the electrolyte during adsorption/desorption. Further, these tunable variances are achieved without the use of metal catalysts, which can lead to blockage of the micropores (depending on the catalyst blending method). Another advantage of the present methods is the ability to create mesopores not just at the surface, but throughout the bulk of the fiber which leads to a much larger enhancement of surface area.

While the methods have been described thus far in terms of individual porous nanofibers, it should be appreciated that such descriptions also includes a plurality of fibers, for example arrange in the form of a mat or web, either free-standing or deposited on a substrate.

Also, whereas the descriptions given thus far are for methods of preparing porous nanofibers, the compositions arising from such methods are also considered within the scope of the present invention. Concerning these nanoporous fibers, or mats or webs thereof, various embodiments provide that the nanofiber have a surface area in the range of about 1200 to about 2000 m²/g, when measured using a nitrogen adsorbent using a multi-point BET method. Such methods are described below. Additional embodiments provide that these nanofibers contain micropores and/or mesopores, where the term “micropores” describes those pore having diameters less than 2 nanometers, and the term “mesopores” describes those pores having diameters in the range of 2 nm to about 50 nm, consistent with the IUPAC definitions for these terms.

In certain embodiments, the nanofiber(s) contains micropores having a cumulative micropore volume in a range of about 0.4 to about 0.8 cc/g, or about 0.6 to about 0.7 cc/g, when measured using a nitrogen adsorbent with assumed slit-shaped pores.

In other embodiments, the nanofiber(s) contains mesopores having a cumulative mesopore volume in a range of about 0.1 to about 1 cc/g, or about 0.2 to about 0.8 cc/g, when measured using a nitrogen adsorbent with assumed slit-shaped pores.

In other embodiments, mats or webs of these nanofibers may be used as the dielectric in capacitor materials. Methods for measuring capacitance properties are described in the appended Attachment. Certain embodiments provide that these porous nanofibers webs or mats exhibit a volumetric capacitance of at least 29 F/cm, under the conditions provided.

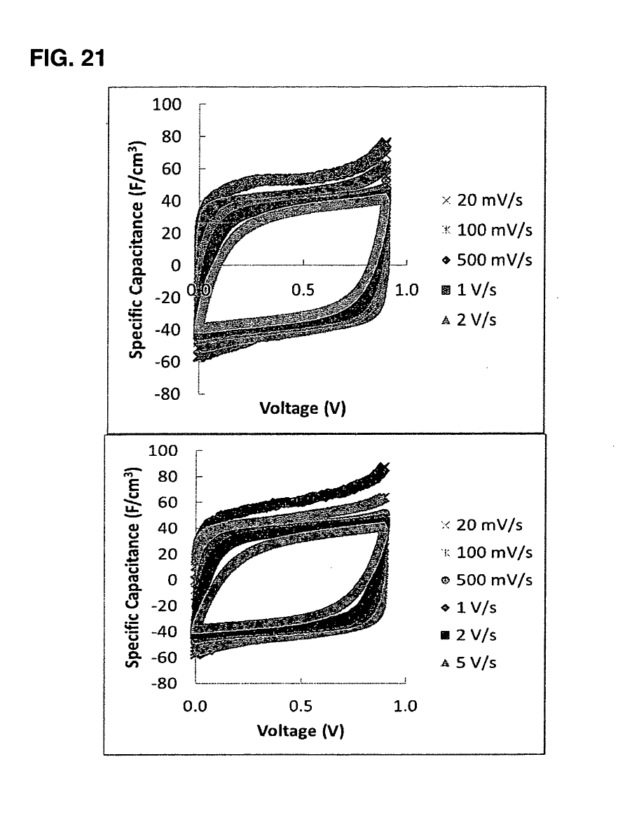

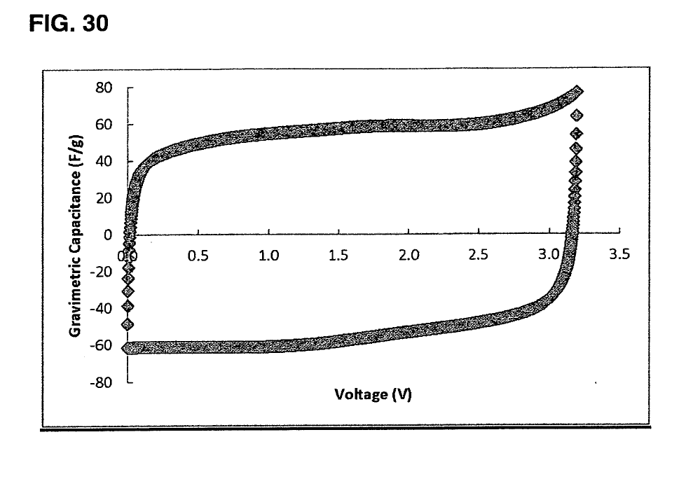

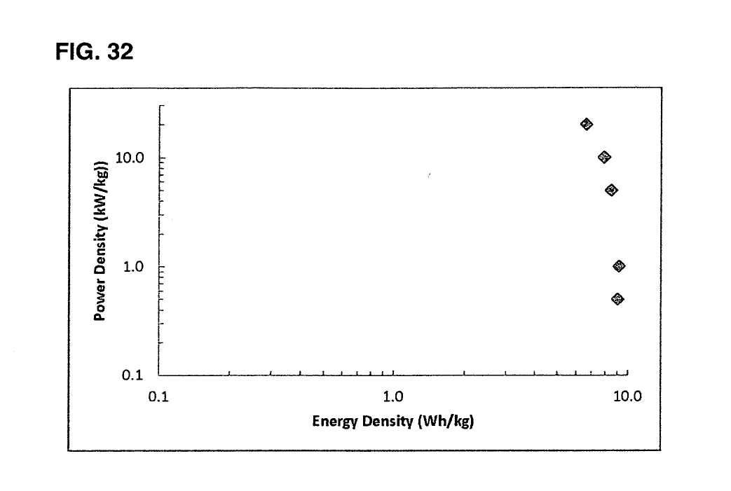

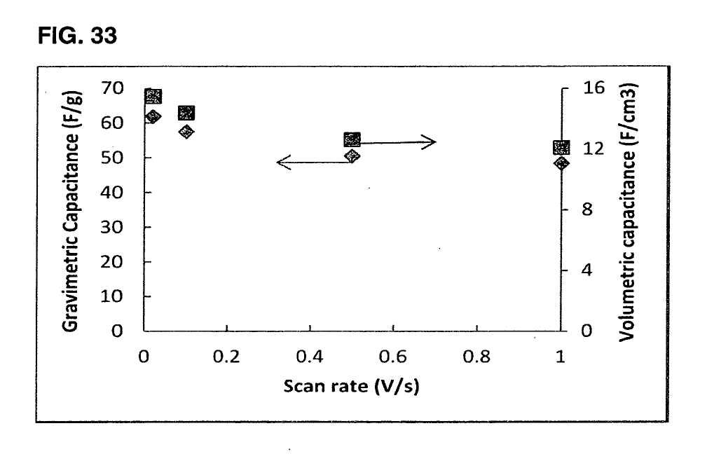

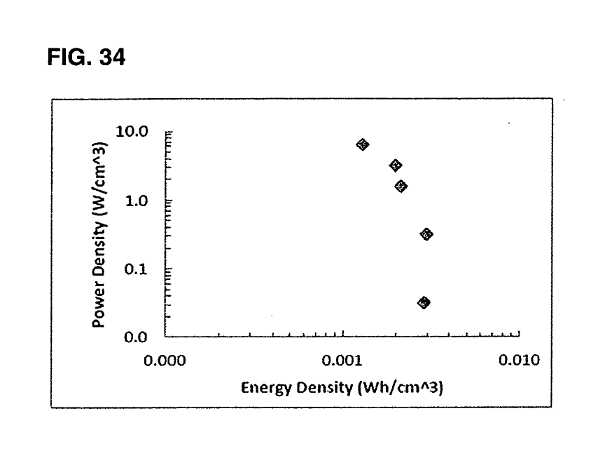

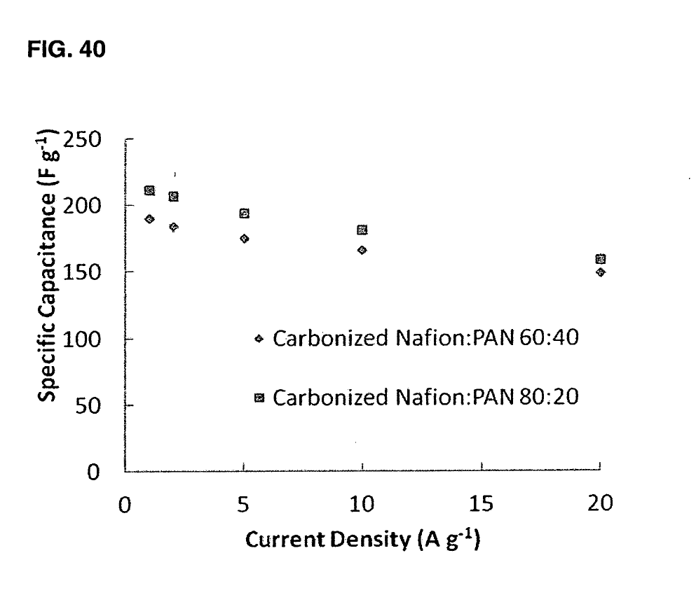

One of the advantages of the instant invention, is the large power handling capability versus conventional systems, such as pure activated carbon based electric double layer capacitors (EDLC). This is evidenced, for example, in FIGS. 21-23, 30, 32, 33, 38, 39 and 40. The high surface area carbons have been found to provide higher capacitance, but at the cost of power. The systems of the instant invention are better in power capacity then current EDLC (FIG. 40).

### Examples

The following examples, while illustrative individual embodiment, are not intended to limit the scope of the described invention, and the reader should not interpret them in this way.

Overall Methodology and Rationale:

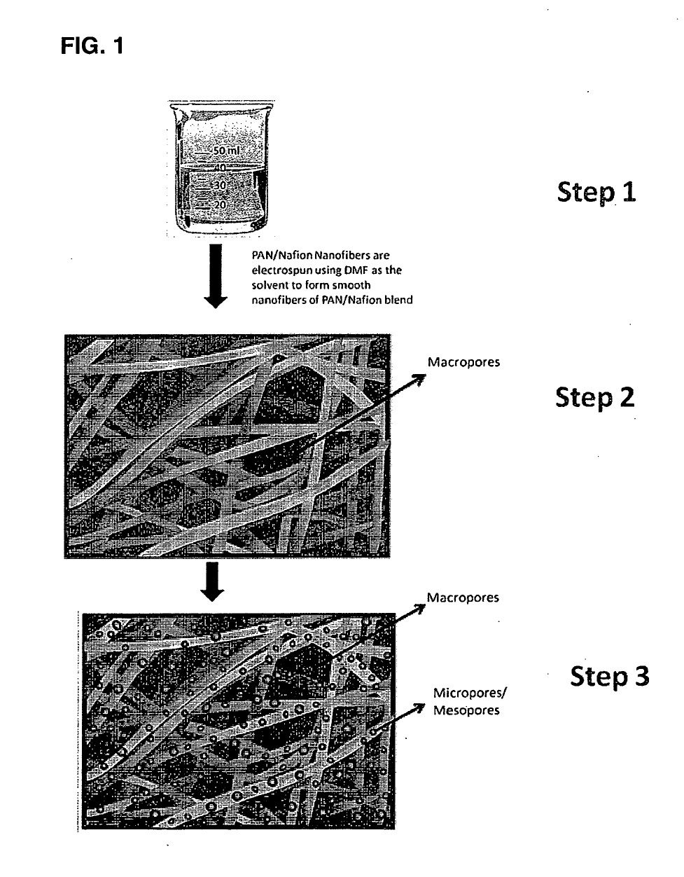

Blends of polyacrylonitrile (PAN) and Nafion were electrospun to form ultra-thin fibers with diameters in the range of 50-300 nm. Polyacrylonitrile is a carbon precursor and can be converted to carbon via a two-step thermal treatment (one embodiment shown in FIG. 1). In the first step, the polyacrylonitrile was stabilized in air atmosphere at a moderate temperature of 280° C. In the next step polyacrylonitrile was calcined at high temperature (700° C. and 800° C.) to form carbon. Nafion serves as a sacrificial polymer which burns away during this thermal treatment leaving behind pores. FIG. 1 shows a schematic of the methodology.

While not intending to be bound by any specific theory, it appears that there are two key factors that govern the final pore structure (size and distribution) within carbon nanofibers:

1) Nano-Assembly of PAN/Nafion Inside the as-Spun Nanofibers.

Electrospinning process involves very rapid solvent evaporation (200 nL/s), which limits the total fabrication time to 1-10 milliseconds and appears to prevent phase separation and kinetically trap the PAN/Nafion blend in a co-continuous homogenous assembly inside the nanofibers.

2) Structural Integrity of the Sacrificial Polymer (Nafion) During PAN Stabilization at 280° C.

While not intending to be bound by any specific theory, it appears that Nafion may be useful in the present invention as a polymer that does not decompose until heated to 400° C., maintains its integrity during PAN stabilization at 280° C., and prevents collapse of the PAN nano-structure inside the nanofibers.

### Detailed Experimental Method

### Fabrication Method

Step 1, Materials:

Nafion powder (prepared by drying a LIQUION 1105 purchased from Ion Power Inc.) and PAN (M_{w}=150000 g mol⁻¹, purchased from Sigma-Aldrich) were dissolved in dimethylformamide (DMF; purchased from Sigma-Aldrich) under gentle heating (ca. 60° C.) and stirring for 1-3 hours. Composition for solution preparation was varied depending on desired pore size distribution (see below).

Step 2, Electrospinning Process:

Fibers were electrospun at room temperature with humidity below 20%. The distance between the tip of the needle (0.4-0.6 mm (20-22 gauge)) spinneret from Hamilton Company) and the grounded collector was 5-6 inches, and the applied voltage of 8-10 kV was used to obtain a stable Taylor cone. The flow rate was kept at a constant 0.5 mL h⁻¹. The nanofibers were deposited on the grounded collector as non-woven nanofiber mats. Examples are given for three different samples varying with respect to PAN/Nafion composition and concentration in DMF of the initial solution:

Sample 1: The nanofibers were electrospun using pure PAN with 10 wt % total solid concentration in initial DMF solution.

Sample 2: The nanofibers were electrospun using 60:40 Nafion:PAN, with a 15 wt % total solid concentration in initial DMF solution.

Sample 3: The nanofibers were electrospun using 80:20 Nafion:PAN, with a 20 wt % total solid concentration in initial DMF solution.

Sample 4: The nanofibers were electrospun using 80:20 Nafion:PAN, with a 25 wt % total solid concentration in initial DMF solution

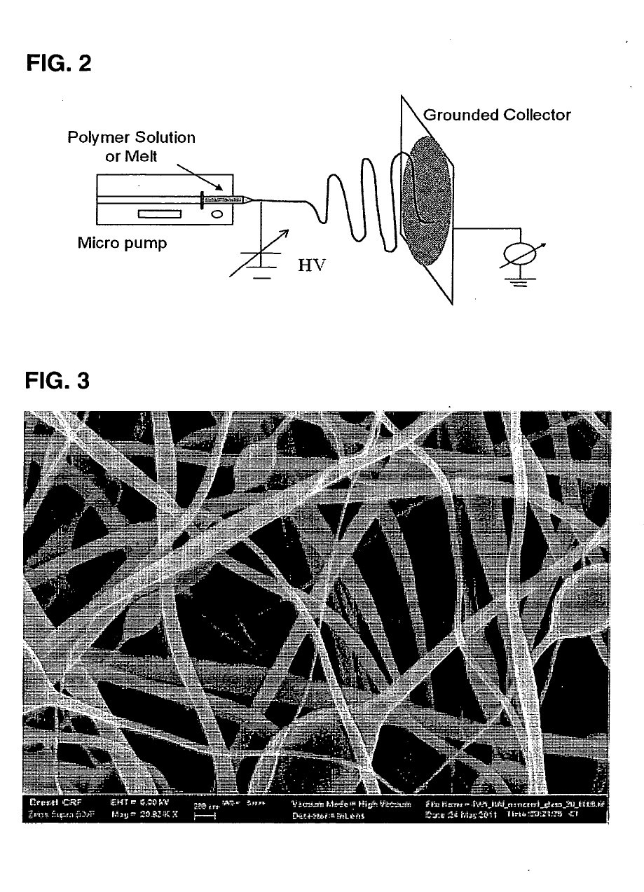

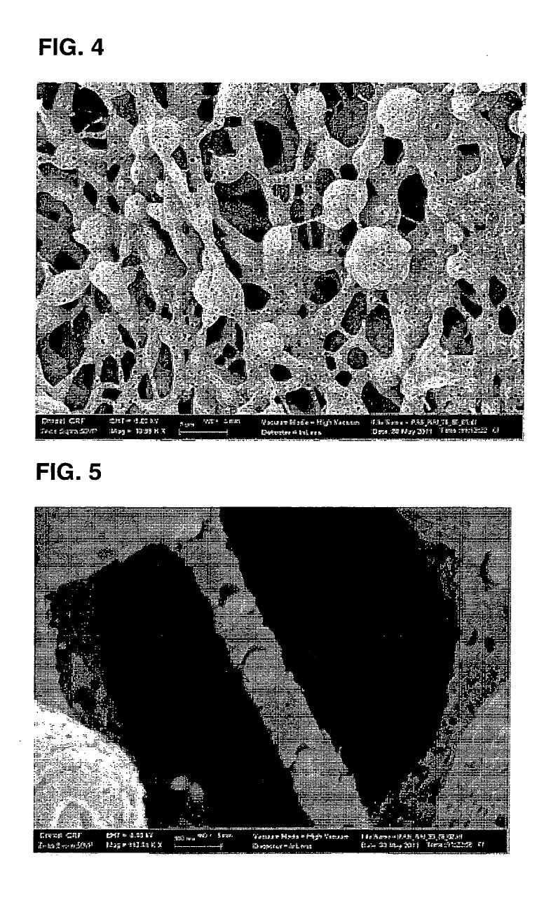

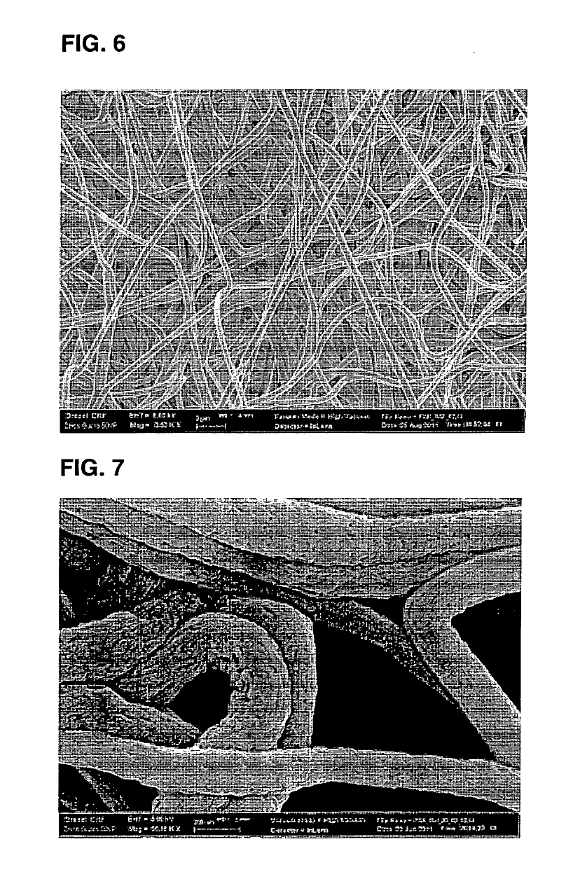

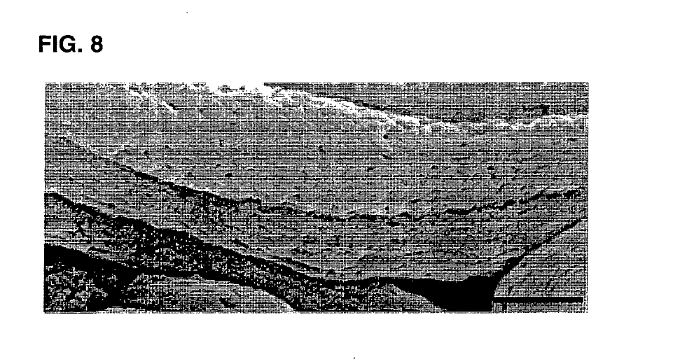

The mats possessed external macropores (d>50 nm; d=pore diameter) between individual nanofibers as shown in FIG. 2(a-d).

Step 3: Calcination Process for Fabrication of Porous Carbon Nanofibers:

The electrospun nanofibers were placed in a horizontal tube furnace and stabilized by heating to 280° C. at a ramp rate of 5° C./min under air flow of 200 mL min⁻¹, and kept at that temperatures for 5 hours in air atmosphere. The air atmosphere was replaced by an argon flow, and the stabilized nanofibers were then carbonized by heating to 700° C. at a rate of 2° C./min and held at 700° C. for 1 hour under argon flow of 400 mL min⁻¹. The carbonized fibers were then heated to 800° C. and held for 1 hour to further increase the conductivity.

This process burned away Nafion and converted PAN to carbon, forming porous carbon nanofibers. The pore size and distribution were varied by varying the composition of PAN/Nafion and the distribution of PAN and Nafion within the nanofibers. The latter in turn can be varied using various process and solution parameters including solution concentration, flow rate, electric field etc. The pores created in this step typically lie within the range of “micro/mesopores” (d<50 nm), where “d” is the pore diameter. See, e.g., FIG. 3(a-d).

### Characterization Method

Nanofibers were characterized using a Zeiss Supra 50VP field-emission scanning electron microscope (SEM) both before and after calcination to study the nanofiber morphology and pore structure. To study the assembly of materials and pore structure inside the nanofibers, nanofibers were microtomed into 60 nm thin sections both along and perpendicular to the fiber axis and characterized using transmission electron microscope (JEOL JEM2100 TEM)

Surface Area and Pore Size Distribution:

Gas adsorption analyses using N₂ (at 77K) as adsorbate were conducted with the Autosorb 6B (Quantachrome Instruments). The samples were treated under vacuum at 200° C. for 24 h before the measurement. The specific surface area was analyzed by using multi-point BET method. The quench solid density functional theory (QSDFT) was used to obtain the pore size distribution with assumed slit-shaped pores.

Capacitance Measurements:

Calcined nanofiber mats were hole punched to obtain circular ⅜ inch diameter pieces. The mass of each piece was weighed with the accuracy of 0.01 mg and the thickness was measured with Mitutoyo micrometer and observed under optical microscope for confirmation. Two pieces of conductive glass (1 cm×1 cm) were used as current collectors. Two-electrode supercapacitor cells were assembled by placing one piece of fiber mat on top of a conductive glass and followed by propylene separator (Celgar 3501), another piece of fiber mat, and a conductive glass. The fiber mats were carefully placed in order to obtain accurate alignment by using a LED light. The whole assembly was clamped with stainless steel binder clips for testing in 1M H₂SO₄. The capacitance of the electrodes was galvanostatically measured with an electrochemical impedance analyzer Solartron 1287A in the potential range of 0-0.8V with a current density of 1-5 mA/cm². The cyclic voltammetry (CV) was performed in the potential range 0-0.8 V with a scan rate of 5-20 mV/s.

Nanofiber Characterization:

The external morphology of electrospun mats was characterized using scanning electron microscopy (Zeiss Supra 50VP). To characterize internal assembly, nanofibers were embedded in epoxy matrix (purchased from Electron Microscopy Science) and then microtomed into thin cross-section and longitudinal sections using a Leica EM UC6 ultramicrotome equipped with a diamond knife. The sections were picked up on lacey carbon copper grids (purchased from Electron Microscopy Science) and characterized using transmission electron microscopy (JEOL JEM2100) operated at 200 kV. The specific surface area (SSA) of CNFs was measured using nitrogen adsorption isotherm at 77K (Autosorb-1, Quantachrome). Prior to the adsorption-desorption measurement, all samples was degassed at 2000° C. under vacuum for 24 h to remove impurities. The pore size distribution (PSD) of CNFs was calculated based on adsorption-desorption curves using the quenched solid density functional theory (QSDFT) with assuming slit-shaped pores. The conductivity of CNFs was measured using a two-point method with stainless steel current collectors. Toray carbon paper with a known conductivity of 11 S cm⁻¹ was used to determine to the contact and circuit resistance. The electrical conductivity, σ, was calculated using by σ=L/(R*A, where L is the electrode thickness, R is the resistance subtracted from the contact and circuit resistance, and A is the electrode area.

Electrochemical Capacitor Performance:

A symmetrical two electrode cell was assembled using two pieces of fabricated CNFs with a diameter of ⅜th inch on two graphite current collectors (with negligible capacitance) and a Celgard 3501 separator in between. The cell was housed inside two Teflon pieces pressed with screws, 1 M H₂SO₄. Cyclic voltammetry was performed with various scan rates from 20 mV/s to 5 V/s in the voltage window from 0-0.9 V. Galvanostatic charge/discharge was carried out at constant current density at 1 A/g for 1 V voltage window. The specific capacitance, C, was calculated by the following equation:

C=(4*I*t)/(ΔV*m) (1)

where I is the current density (A/g), Δt is the discharging time, m is the total mass of CNFs, and ΔV is the voltage window. The energy densities, E, were evaluated as a function of constant discharge power densities from 0.1 kW/kg to 20 kW/kg by the following equation:

$$E = [ \int I * V * d t ] E = \frac{\int I * V * d t}{m} / m \qquad ( 2 )$$

where all variables are defined as earlier. Electrochemical impedance spectroscopy (EIS) was measured in the frequency range from 100 kHz to 20 mHz with an alternating current amplitude of 10 mV at open circuit voltage. All electrochemical measurements were carried out with potentiostat Gamry Reference 3000.

### Production of Nanofibers, Mats and Web and Characterization of Same

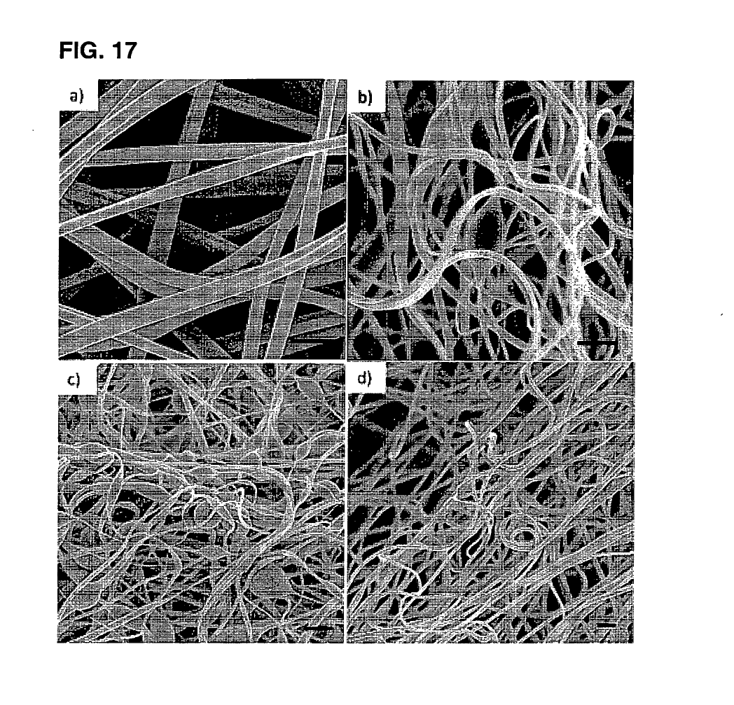

The solutions of Nafion/polyacrylonitrile (PAN) in DMF were electrospun over a range of different mass ratios (FIG. 17). As Nafion:PAN weight ratio is increased, a raise in the total solid concentration in DMF is required to obtain smooth and bead-free nanofiber mats. For example, as shown in FIG. 17, 60:40 (wt:wt) Nafion:PAN forms smooth nanofibers with a total solid concentration of 15 wt % in DMF. However, when the blend composition is changed to 80:20 (wt:wt) Nafion:PAN, bead-on-fiber morphology (FIG. 17c) is observed even at 20 wt % total solid concentration in DMF. Uniform nanofibers (FIG. 17d) are obtained on increasing the total solid concentration to 25 wt %. This effect is attributed to the presence of Nafion aggregates in the solution (owing to electrostatic interactions) that lead to decrease in chain entanglement and loss of extensional viscosity. Therefore, an increase in the total solid concentration is required to compensate for the increasing Nafion content.

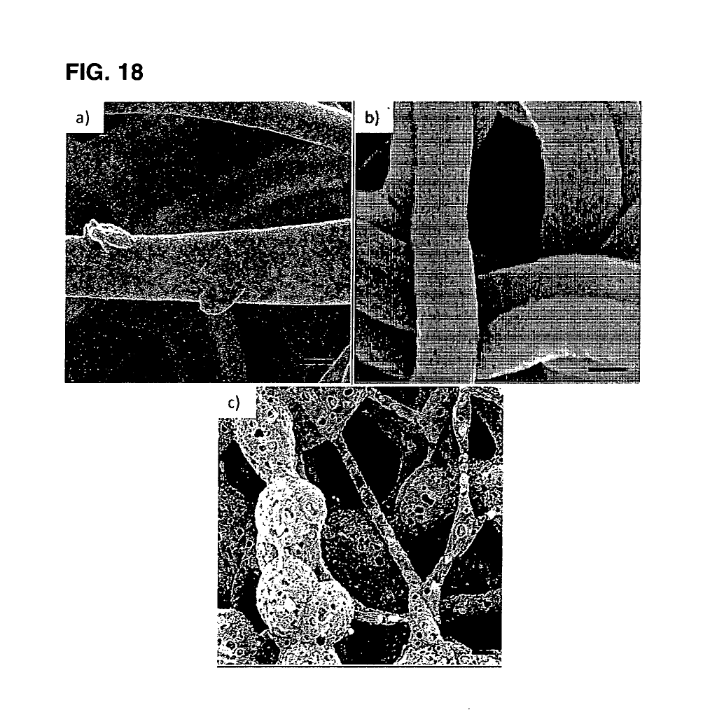

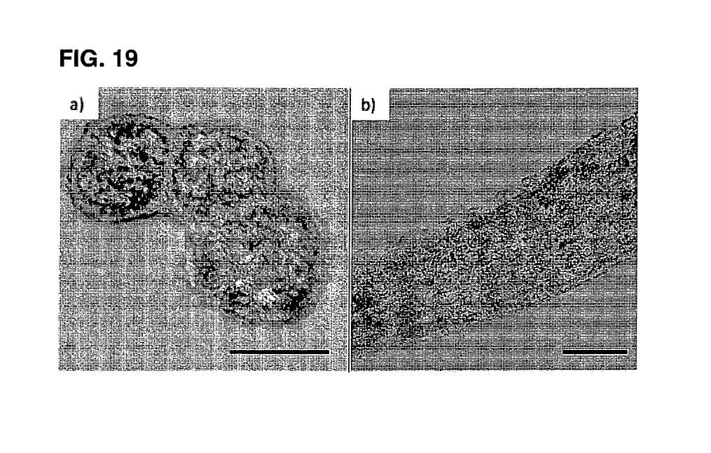

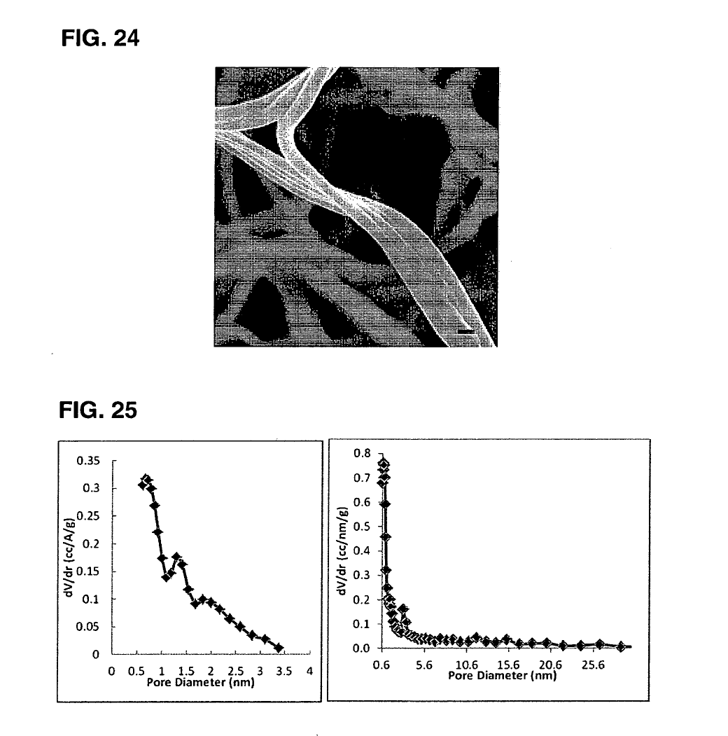

To fabricate porous carbon nanofibers (CNFs), the blend nanofibers were subjected to oxidative stabilization and calcination procedures described in the experimental methods section. During the oxidative stabilization step (at 280° C.), no pore formation is seen in any sample (FIG. 24) indicating that the Nafion is largely intact during the stabilization step. The high onset decomposition temperature of about 380° C. and excellent rigidity of Nafion allowed the Nafion domain to retain its structural integrity while the PAN domain underwent complex chemical reactions to transform into the stabilized ladder structure. It is believed and hypothesized that this property of the sacrificial polymer is critical because premature degradation of the sacrificial polymer before PAN stabilization (at 280° C.) will lead to closing up of the newly-developed pores. This hypothesis can possibly explain the lack of clear porosity, and modest increase in surface area in earlier works that utilized binary blends of PAN and a sacrificial polymer (different from Nafion). As expected, based on the hypothesis, prominent porous carbon structures (FIG. 18) appeared after heating to 800° C. under inert atmosphere due to selective removal of Nafion and conversion of PAN to carbon. When the Nafion/PAN weight ratio was 60:40, small crack-like pores were seen on fiber surfaces in SEM images (FIG. 18a). However, the TEM images of both longitudinal section and cross-section of the same sample (FIG. 19) showed a clear internal porous structure. The pores are interconnected within the carbon domains. As the Nafion content in the precursor increases from 60% to 80%, the pores become bigger, and the fibers still retain their overall morphology after calcination.

Note that the densities of Nafion and PAN are 1.7 and 1.2 cc g⁻¹ respectively; therefore the volume ratio of Nafion:PAN in the 80:20 wt:wt sample is ˜75:25. It is very interesting how even at only 25 volume % PAN, the Nafion:PAN CNFs do not collapse after selective removal of Nafion during calcination and show a uniform porous structure (FIG. 18b). The two following factors may have partially contributed to this effect. First, Nafion after drying at 80° C. for 24 h is still absorbing more than 10% water by weight, which implies that the dry Nafion volume fraction is slightly lower than the calculated 75%. Secondly, the fiber diameter decreased from 250 nm to 200 nm after carbonization/calcination. A rough calculation will yield carbonized fibers with a volumetric ratio of 45:55 of solid carbon to intra-fiber pores. With 55% solid, it is reasonable that the fibers still retain the shape after carbonizing 80:20 Nafion:PAN sample. Nevertheless, the retention of fiber morphology after calcination and the presence of interconnected pore structure as seen in the TEM images implies that the PAN in the as-made nanofibers exhibits a continuous percolating domain, which when converted to carbon prevented the fiber from collapsing. We believe that the fast solvent evaporation and short residence time during electrospinning prevents complete phase separation of PAN and Nafion and kinetically traps the materials into a co-continuous assembly within nanofibers. Please refer to our recent paper that presents the TEM analysis of internal as-made nanofiber structures showing co-continuous assembly of PAN and Nafion. FIGS. 18b and 18c shows the effect of initial solution concentration on pore sizes after calcination. Here both samples were electrospun using 80:20 weight ratio of PAN:Nafion, but the initial concentration of the solid in DMF was 25 and 20% respectively. As we decrease the solution concentration, the pore size after calcination increased. We believe that the relaxation time of polymers during electrospinning for the sample with low solution concentration is shorter compared to those with high solution concentration. As a result, the domains of microphase separation are larger for the sample with shorter relaxation time, which leads to bigger pore size upon calcination.

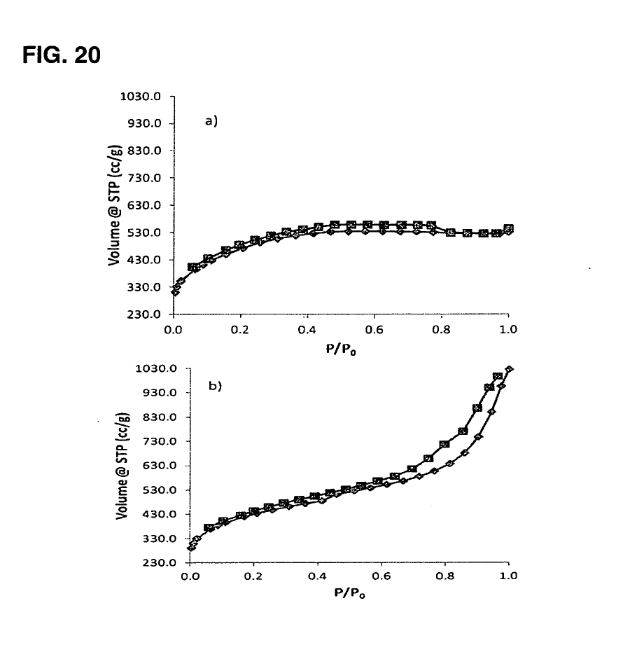

The pore size distribution (PSD), specific surface area, and pore volumes of porous CNFs were studied with the nitrogen adsorption isotherms (FIG. 20). The volume of adsorbed nitrogen of calcined 80:20 Nafion:PAN increased slowly with relative pressure indicating the presence of a significant amount of mesopores. On the other hand, the calcined 60:40 Nafion:PAN is leveled off at an intermediate pressure indicating the presence of a majority of micropores with a small amount of mesopores. Given that the desorption branch lies above the absorption branch, both hysteresis loops, obtained for calcined 60:40 Nafion:PAN and 80:20 Nafion:PAN are associated with slit shaped pores. A summary of calculated BET surface area, total pore volume, volume of micropores, and average pore size from isotherms is listed in Table 1. The average pore size increased from 1.35 to 4.69 nm with increase of Nafion content from 60% to 80%. This is understandable as more sacrificial polymers are removed to create bigger pores. However, in spite of the increase in pore size, we do not see any significant decrease in surface area (1614 m² g⁻¹ for 60% Nafion to 1499 m² g⁻¹ for 80% Nafion), which can be attributed to a significant increase in the overall pore volume in the calcined 80:20 Nafion:PAN (1.336 cc/g) compared to calcined 60:40 Nafion:PAN (0.822 cc/g). Kim et at (B.-H. Kim, K. S. Yang, H.-G. Woo and K. Oshida, Synthetic Metals, 2011, 161, 1211-1216) obtained 237 m² g⁻¹ for carbonized pure PAN, while other researchers obtained up to 550 m² g⁻¹ for blends of PAN with polyvinylpyrrole. It is obvious that the use of Nafion as a sacrificial polymer allowed us to fabricate porous CNFs with a surface area three times higher than previous works. Even though the pore size distributions are broad (FIG. 25), the benefit of adjustable pore size and high specific surface area (SSA) are extremely attractive for the study in supercapacitors with organic electrolytes at high current densities. In addition, the presence of interconnected pores as seen in TEM study in FIG. 19, is believed to be extremely beneficial in supercapacitor applications owing to greater electrolyte accessibility.

TABLE 1
Values of SSA, pore volume, average
pore size acquired from N₂ sorption.

| | BET | | | Cumulative | |
|---|---|---|---|---|---|
| | SSA | V_{micro} | Vₘₑₛₒ | Pore Volume | Average |
| | (m² g⁻¹) | (cc g⁻¹) | (cc g⁻¹) | (cc g⁻¹) | size (nm) |
| Nafion:PAN | 1614 | 0.641 | 0.181 | 0.822 | 1.35 |
| 60:40 | | | | | |
| Nafion:PAN | 1499 | 0.526 | 0.810 | 1.336 | 4.69 |
| 80:20 | | | | | |

TABLE 2
Values of conductivity and gravimetric capacitance
of different carbonized samples.

| | Conductivity | Specific Capacitance (F g⁻¹) |
|---|---|---|
| | (S cm⁻¹) | at 1 A/g |
| Nafion:PAN 0:100 | 0.23 | 20 |
| Nafion:PAN 60:40 | 0.15 | 190 |
| Nafion:PAN 80:20 | 0.13 | 210 |

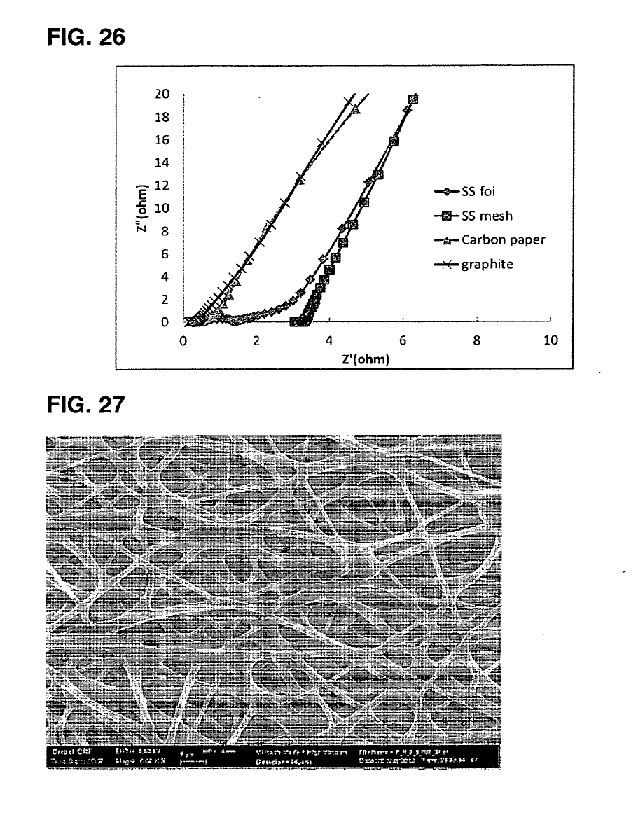

To study the performance of nanofiber mats as electrodes in supercapacitors, resulting porous CNFs were punched into circular shaped mats with a diameter of ⅜^{th} inch and used as free-standing electrodes as-is without the addition of any binder or conductive material. We found that the use of graphite as the current collector allowed us to achieve a lower resistance due to improved contact between the electrode and the current collector which is indicated by the x-intercept of Nyquist plot at high frequencies (FIG. 26). FIG. 21 shows the cyclic voltammograms of calcined 60:40 and 80:20 Nafion:PAN samples at various voltage scan rates. As seen from FIG. 21, both calcined 60:40 Nafion:PAN and 80:20 Nafion:PAN show near-rectangular cyclic voltammetry curves at both slow and fast scan rates (up to 2V s⁻¹) indicating a fast charge/discharge behavior and a low resistance of materials. This behavior is very promising since activated carbon with SSA of 2500 m² g⁻¹ showed deviation from an ideal rectangular shape at only 100 mV s⁻¹ scan rate with about 75 F g⁻¹ specific capacitance in 0.5M K₂SO₄. At the scan rate of 20 mV s⁻¹, Calcined 60:40 Nafion:PAN and 80:20 Nafion:PAN exhibit large volumetric capacitances of 53 and 60 F cm⁻³ respectively in spite of the relatively low packing density of electrospun nanofiber mats. Past work on electrospun carbide derived carbon nanofibers yielded a capacitance of only 12 F cm⁻³ in 1 M H₂SO₄. Further improvement of packing density and hence the volumetric capacitance can be made by hot pressing before calcination and this work is currently underway.

Table 2 shows the electrical conductivity and gravimetric specific capacitance measured via charge-discharge experiments for three different calcined samples with the following initial Nafion:PAN weight ratio; 0:100 (pure PAN), 60:40 and 80:20. As expected, the conductivity reduces as the pore volume increases from 0.23 S/cm in calcined pure PAN to 0.13 S/cm in calcined 80:20 Nafion:PAN nanofibers. The gravimetric specific capacitances measured via charge-discharge experiments at 1 A g⁻¹ current density are 190 and 210 F g⁻¹ for calcined 60:40 Nafion:PAN and 80:20 Nafion:PAN respectively (Table 2). Similar experiments were conducted on calcined pristine PAN nanofibers (non-porous) as reference and they exhibited a capacitance of only 20 F/g corroborating the advantage of pores within individual nanofibers. For comparison, specific capacitance of activated CNFs fabricated using an additional high temperature activation procedure after carbonization has been reported to be up to 180 F g⁻¹ at the same discharge current density. The use of sacrificial Nafion to create porous CNFs not only allowed a one-step fabrication process, but also allowed us to further improve the performance compared to activated CNFs.

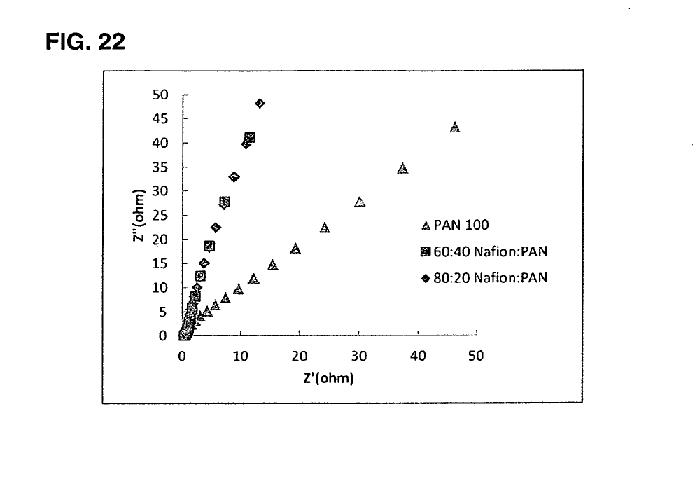

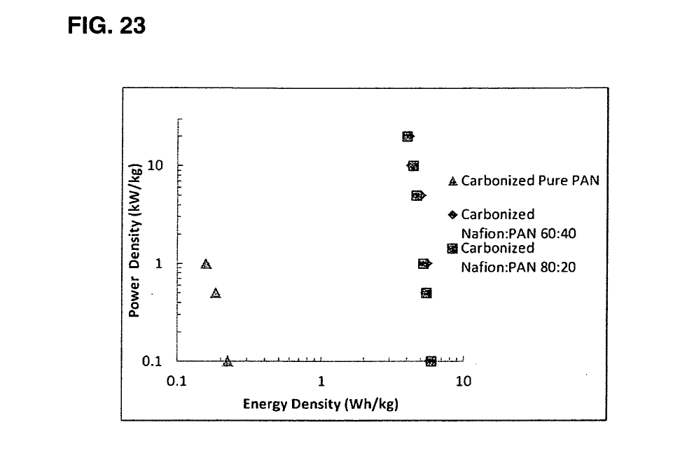

Note that although the 80:20 Nafion:PAN sample had a slightly smaller surface area and lower conductivity than 60:40 Nafion:PAN, its gravimetric and volumetric capacitance is higher than 60:40 Nafion:PAN. The bigger pore size of 80:20 Nafion:PAN allowed enhanced ion diffusion and provided more accessible carbon surface area leading to improved performance. Chmiola et al. (J. Chmiola, G. Yushin, Y. Gogotsi, C. Portet, P. Simon and P. Taberna Science, 2006, 313, 1760-1763) studied the effect of pore size on the performance of supercapacitor by using carbide-derived carbon, and showed a decrease of normalized capacitance when the pore size was reduced to ˜1 nm. A similar trend was observed with the instant materials. Note that we currently use aqueous H₂SO₄ as the electrolyte that consists of solvated ions of size ˜1 nm; therefore both our porous nanofiber samples provide large enough pore sizes for ion diffusion and hence the specific capacitance increase in 80:20 Nafion:PAN sample is not as drastic. Ability to increase pore size and yet maintain a high specific surface area, will be particularly beneficial with organic electrolytes that typically have larger solvated ion sizes than aqueous solutions. Use of organic electrolytes is critical for most industrial applications as they allow capacitor operation at much higher voltages (up to 3V) than aqueous electrolytes (1 V) and therefore allow improved energy density, which is proportional to V². Study on effect of pore size in organic electrolytes is currently underway. FIG. 22 shows the AC impedance measurements of porous CNFs. The Nyquist plots of calcined 60:40 Nafion:PAN and 80:20 Nafion:PAN showed small depressed arcs at high frequencies and steep linear slopes at low frequencies. The same experiment was conducted on calcined pure PAN (non-porous carbon nanofiber mat) as reference, which showed a gentle 45° slope at low frequencies. This indicates that both porous nanofiber samples poses a small charge transfer resistance and fast kinetics of ion adsorption to the electrode. Finally, Ragone plots were constructed by varying the discharging power densities from 0.1 kW kg⁻¹ to 20 kW kg⁻¹ (FIG. 23). It is interesting that there was not much reduction in the energy density upon increasing the power density for both calcined samples with Nafion, i.e. porous carbon nanofibers. This behavior is often associated with fast kinetics of ion diffusion and adsorption to the electrode surface which is related to structural advantages as described earlier. An energy density of 4 Wh kg⁻¹ at a power density of 20 kW kg⁻¹ was achieved. It must be noted that these values are evaluated based on the mass of two electrodes and the voltage of the cell without including the mass of the current collectors, separator, and the electrolytes.

Additional nanofibers were electrospun using 60:40 Nafion:PAN. The total solid concentration in initial solution (with DMF as solvent) was 15%. Some figures presented herewith indicate that the sample was pressed. This implies that the samples were pressed between two pieces of glass and calcined at 10000 C. Remaining samples were not pressed prior to calcination. Calcination of all samples was done using the following procedure:

A. Sample was heated from room temperature to 280° C. at a ramp rate of 5° C./min and then kept at 280° C. for 5 hours in Air atmosphere; and

B. Sample was then exposed to Argon (inert) atmosphere and heated from 280° C. to 700° C. at a ramp rate of 5° C./min and then kept at 1000° C. for one hour. FIG. 27 provides a typical image of pressed and calcined sample.

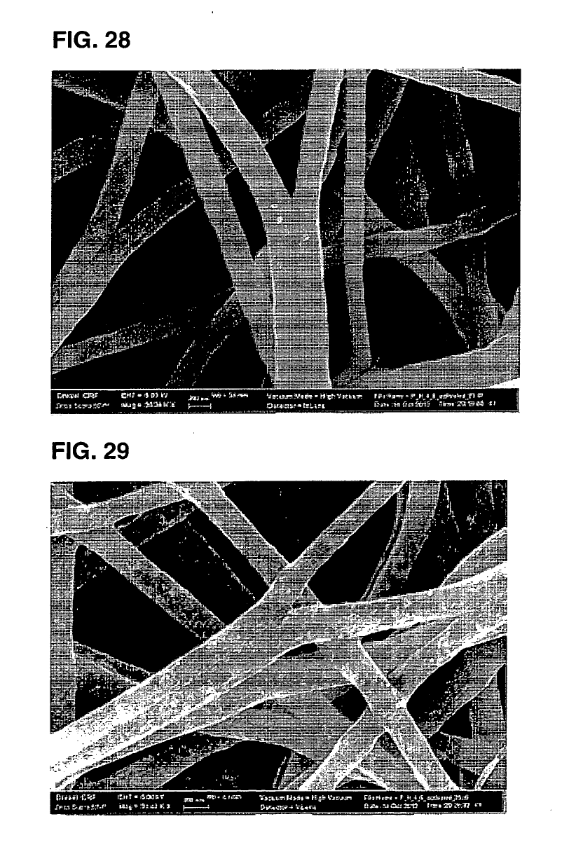

Some samples (see FIGS. 28 and 29) were activated. For activation, the pressed and calcined porous carbon nanofibers were submerged in different KOH solution concentrations for 12 h, blotted with paper to remove the excess, and then heated to 800° C. for 30 mins under nitrogen.

In some embodiments, the fibers (in the form of a mat or web, in some embodiments) are pressed and then contacted with an alkaline solution. In some methods, the alkaline solution is an aqueous KOH solution. One preferred KOH solution is an aqueous KOH solution having 10-65 percent by weight of KOH, 20-60% by weight in some embodiments.

Note that in certain embodiments, all nanofiber mats were used as-is in their inherent free-standing form. No binders or any special electrode casting processes were used. The electrochemical characterizations were performed using the methodology described herein or by known methods. All measurements were made using a two-electrode symmetric cell incorporating the mass/volume of both electrodes for the energy density, and specific capacitance measurements. Note that several literature articles report measurements using 3-electrode cells and incorporate the mass/volume of only one electrode, which can lead to over-estimation of specific capacitance and energy density by up to 4 folds. Note that all of the data below has been obtained in organic electrolyte (unlike the previous data provided, which was in aqueous electrolyte). The specific capacitance reduces as expected; however, organic electrolyte allows us access to higher voltage windows thereby improving energy density.

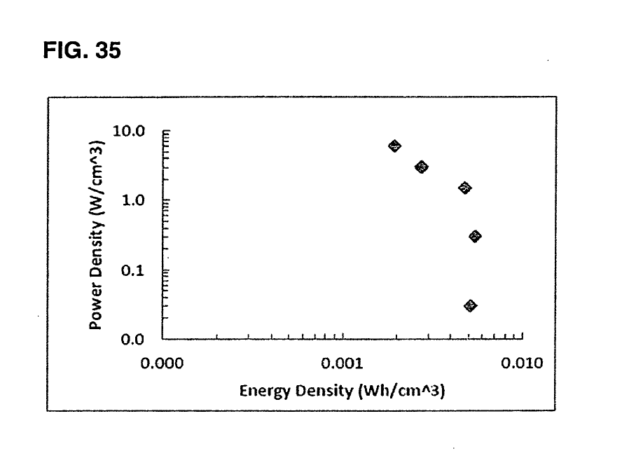

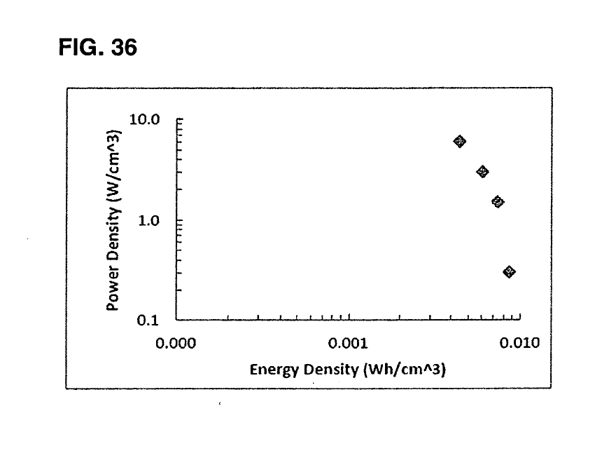

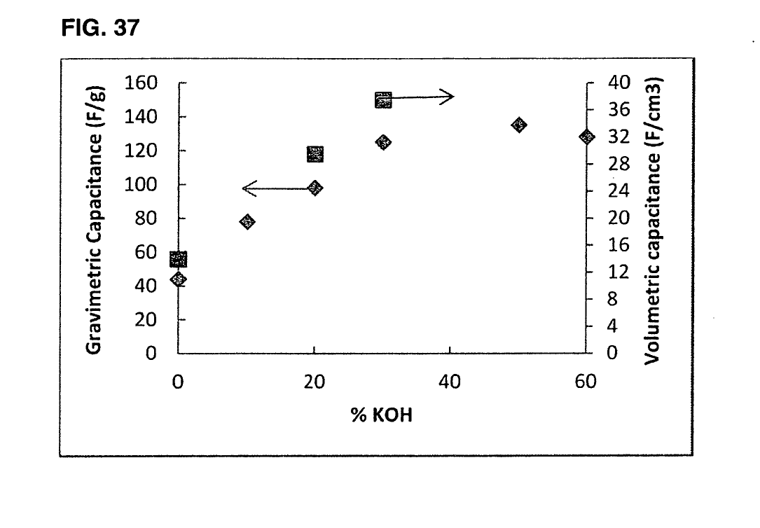

FIGS. 35-37 show results for samples that were also activated after fabrication of porous carbon nanofibers to further increase porosity. This process adds micro-pores to the material and is similar to the commercial process, while retaining the meso-porosity of our nanofibers, which allows improved access by the electrolyte. The activation and pressing allows to recover a high capacitance (>30 F/cm3) even in the organic electrolyte with the added advantage of large voltage window.

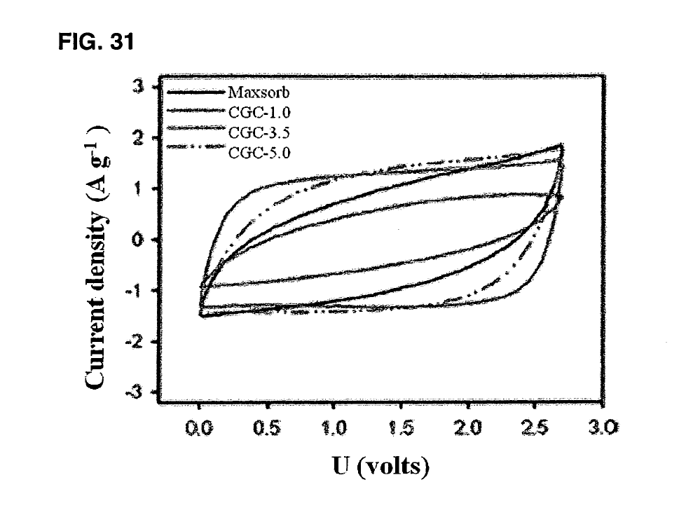

FIG. 31 shows the performance of commercial activated carbon Maxsorb for comparison. Note the lower voltage window, and also the non-ideal non-rectangular CV behavior even at low 50 mV/s scan rate.

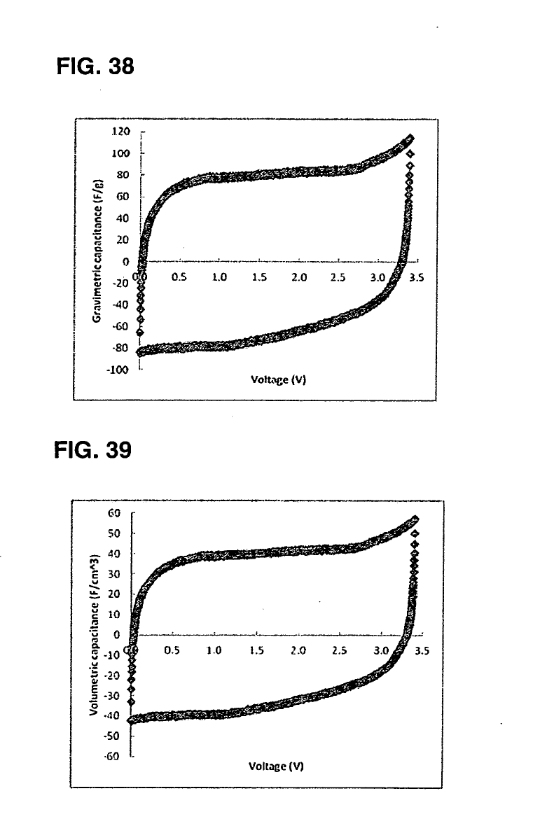

In an additional example, nanofibers were electrospun using 60:40 Nafion:PAN. The total solid concentration in initial solution (with DMF as solvent) was 15%. The samples were hot pressed at 300 deg. C prior to calcination at 1000 deg. C. FIG. 38 presents results of a test at 5 mV/s scan rate showing 81 F/g capacitance in 1M TEABF₄/acetonitrile. FIG. 39 shows results from a test at 5 mV/s scan rate showing 41 F/cm³ capacitance in 1M TEABF₄/acetonitrile. Note the sample is stable up to 3.4 V.

In summary, the fabrication of highly porous, high surface area carbon nanofibers (CNFs) by electrospinning a blend of PAN and Nafion followed by high temperature calcination was demonstrated. The high decomposition temperature of Nafion prevented its premature degradation before PAN stabilization and allowed the formation of well-defined pore structure upon complete carbonization of PAN and selective decomposition of Nafion. It must be recognized that any polymer with high decomposition and chain rigidity can be a substitute candidate for Nafion to create high surface area porous CNFs. In addition, tunability of pore size within nanofibers was demonstrated with the use of different blend compositions. These materials possess excellent performance with a specific capacitance of greater 200 F/g at relatively high rate capability when applied as electrodes for supercapacitors. This is attributed to the large surface area and large fraction of mesopores that allows improved electrode surface accessibility. These materials exhibited high power density without a significant reduction of energy density indicating fast kinetics of ion diffusion and adsorption. Study on fabrication and performance measurements (in organic electrolytes) of porous carbon nanofibers using alternative sacrificial polymers is underway.

Key conclusions include:

1) Volumetric capacitance of 61 F/cm³ has been shown. Stability tests have been conducted and the capacitance value is retained even after 150 charge-discharge cycles.

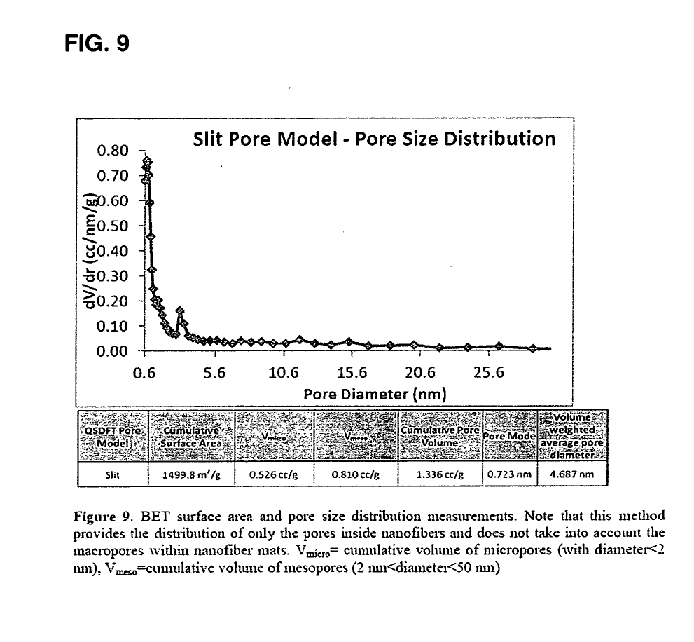

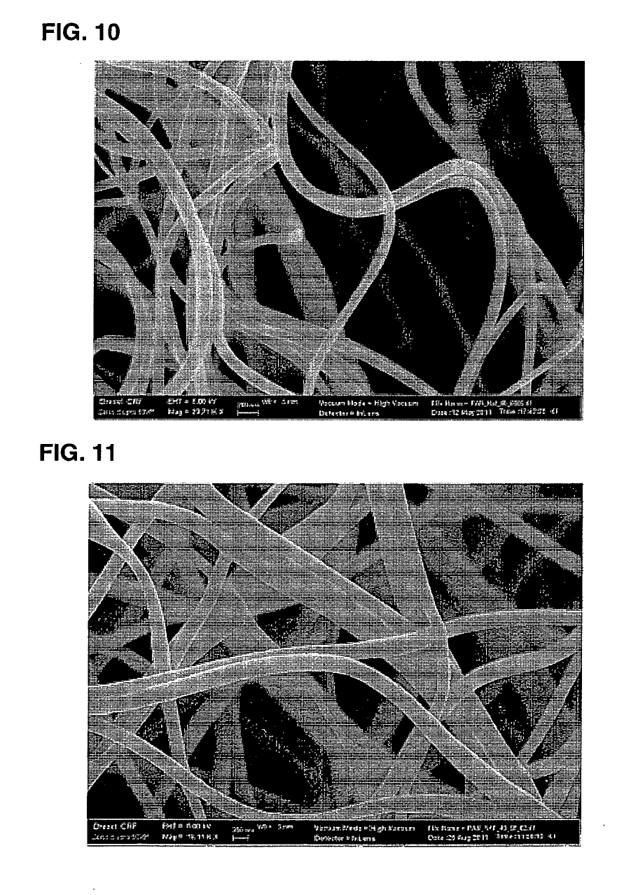

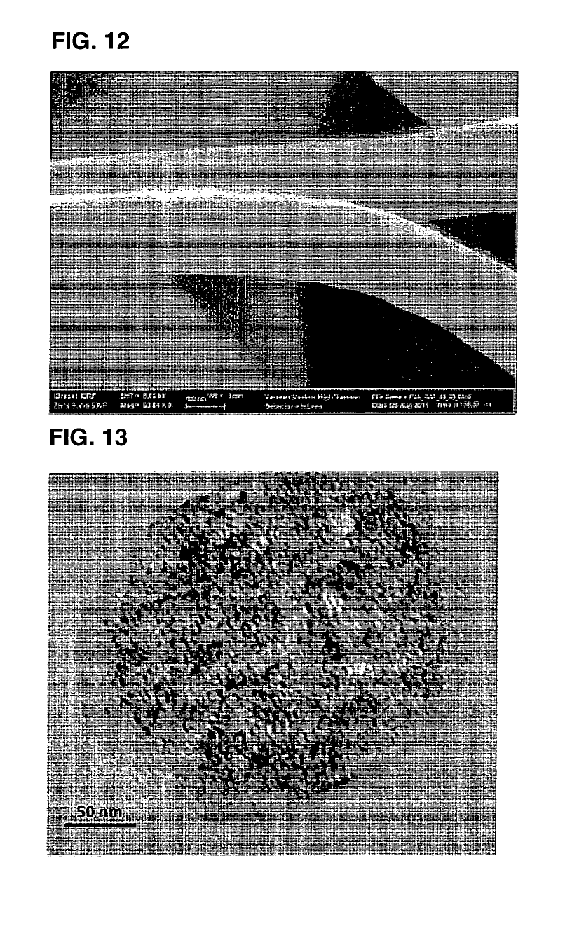

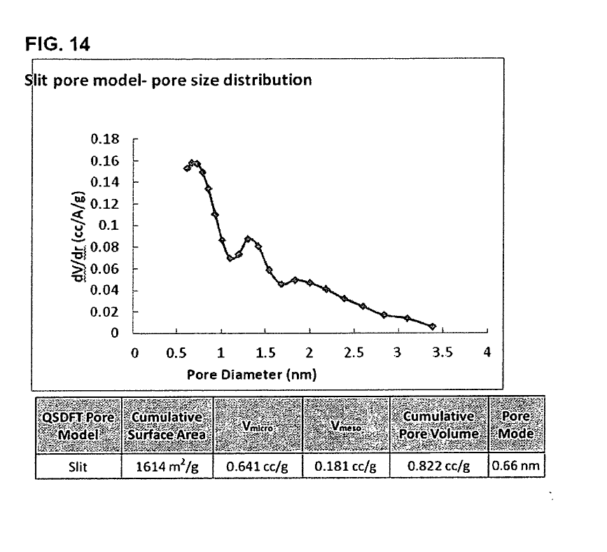

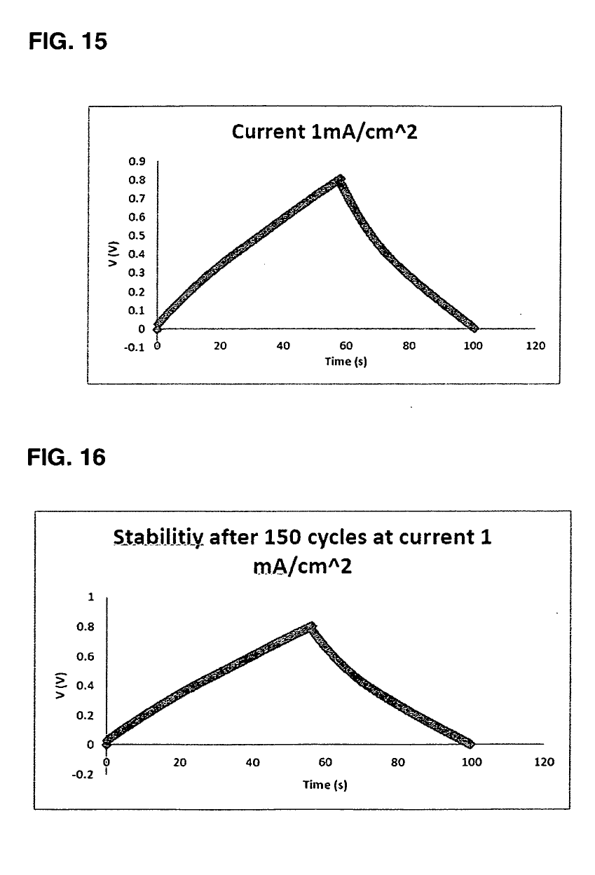

2) As seen from SEM and gas adsorption analysis, the pore diameter and mesopore volume progressively decreases from sample 1 to sample 2 to sample 3. As an example (FIGS. 9 and 14), the volume of pores changes from (Vmicro=0.526 cc/g, Vmeso=0.810 cc/g) in sample 2 to (Vmicro=0.641 cc/g, Vmeso=0.181 cc/g) in sample 3, where Vmicro is the cumulative volume of micropores (with diameter<2 nm) and Vmeso is the cumulative volume of mesopores (2 nm<diameter<50 nm).

The decrease in mesopore volume from sample 2 to sample 3 is due to the decrease in Nafion content leading to smaller pore size. However, the decrease in pore volume from sample 1 to sample 2 is very interesting as the Nafion content in PAN/Nafion blend is the same in both samples. The key difference is the solution concentration. Without being bound by any particular theory, it is believed that the relaxation time for the polymers in sample 1, owing to lower solution concentration, is faster compared to those in sample 2. As mentioned earlier, owing to the short residence time during electrospinning, the PAN/Nafion blend gets kinetically trapped in a homogenous, co-continuous state and phase separation, which is the equilibrium low energy state does not take place. Owing to the faster relaxation in sample 2 compared to sample 3, sample 2 is closer to the final phase separated state and gets kinetically trapped with larger PAN/Nafion domain size compared to sample 3, thereby leading to larger pore diameter.

As those skilled in the art will appreciate, numerous modifications and variations of the present invention are possible in light of these teachings, and all such are contemplated hereby. For example, in addition to the embodiments described herein, the present invention contemplates and claims those inventions resulting from the combination of features of the invention cited herein and those of the cited prior art references which complement the features of the present invention. Similarly, it will be appreciated that any described material, feature, or article may be used in combination with any other material, feature, or article, and such combinations are considered within the scope of this invention.

The disclosures of each patent, patent application, and publication cited or described in this document are hereby incorporated herein by reference, each in its entirety.

What is claimed:

1. A method for forming a porous carbon nanofiber, comprising:
electrospinning a polymer blend comprising polyacrylonitrile and a sulfonated polymer dissolved in a solvent to form a fibers;
heat treating the fibers sequentially at first, second, and optionally third temperatures to produce heat treated porous carbon nanofibers; and
optionally treating the heat treated porous carbon nanofibers with an oxidizing agent.

2. The method of claim 1, wherein the sulfonated polymer is Nafion.

3. The method of claim 1, wherein the solvent is toluene, dimethylformamide, chloroform, dichloromethane, dimethylacetamide, acetone, N-methylformamide, N-methylacetamide, N-methylpropanamide, N-ethylacetamide, N-propylpropanamide, N-butylacetamide, N-ethylformamide, or a mixture thereof.

4. The method of claim 1, wherein the solvent is dimethylformamide.

5. The method of claim 1, wherein the polymer blend comprises polyacrylonitrile at a concentration in the range of about 5 wt % to about 95 wt %, relative to a total weight of polymer.

6. The method of claim 1, wherein the polymer blend comprises polyacrylonitrile at a concentration in the range of about 20 wt % to about 50 wt %, relative to a total weight of polymer.

7. The method of claim 1, wherein the polymer blend comprises Nafion at a concentration in the range of about 5 wt % to about 95 wt %, relative to a total weight of polymer.

8. The method of claim 1, wherein the heat treating the fibers at the first temperature is conducted in an oxygen-containing atmosphere at a temperature in the range of about 250° C. to about 300° C.

9. The method of claim 8, wherein the oxygen-containing atmosphere is air.

10. The method of claim 1, wherein the sulfonated polymer has a decomposition temperature in air above the first heat treating temperature.

11. The method of claim 1, wherein the heat treating of the fibers at the second temperature is conducted in an inert atmosphere at a temperature in the range of about 650° C. to about 1500° C.

12. The method of claim 1, wherein the heat treating of the fibers is done at a third temperature, wherein said heat treating at the third temperature is conducted in an inert atmosphere at a temperature in the range of about 750° C. to about 1500° C.

13. The method of claim 12, wherein the inert atmosphere is argon.

14. The method of claim 1, wherein the heat treated porous carbon nanofibers are treated with an oxidizing agent, said oxidizing agent comprising steam.

15. The method of claim 1, wherein the heat treated porous carbon nanofibers are in the form of a mat or web.

16. The method of claim 15, wherein the mat or web is pressed and then contacted with an alkaline solution.

17. The method of claim 16, wherein the alkaline solution is an aqueous KOH solution.

18. The method of claim 17, wherein the concentration of KOH in the aqueous KOH solution is in the range of about 10 to about 65 percent by weight.

19. A porous nanofiber containing micropores and mesopores prepared by the method of claim 1.

20. The porous nanofiber of claim 19, wherein the nanofiber has a surface area in the range of about 1200 to about 2000 m²/g, when measured using a nitrogen adsorbent using a multi-point BET method.

21. The porous nanofiber of claim 19, wherein the nanofiber contains micropores having a cumulative micropore volume in a range of about 0.4 to about 0.8 cc/g, when measured using a nitrogen adsorbent with assumed slit-shaped pores.

22. The porous nanofiber of claim 21 comprising pores in the range of about 1 to about 10 nm within the fiber.

23. The porous nanofiber of claim 19, wherein the nanofiber contains mesopores having a cumulative mesopore volume in a range of about 0.1 to about 1 cc/g, when measured using a nitrogen adsorbent with assumed slit-shaped pores.

24. The porous nanofiber of claim 19, wherein the sulfonated polymer has a decomposition temperature above about 280° C.

25. A plurality of porous nanofibers of claim 19, wherein the plurality of nanofibers is in the form of a mat or web.

26. The plurality of porous nanofibers of claim 25, which exhibit a volumetric capacitance of at least 20 F/cm³.
